(19) United States
(12) Patent Application Publication
(10) Pub. No.: US 2009/0068435 A1
(43) Pub. Date: Mar. 12, 2009

(54) THICK FLOOR COATING HAVING ANTISTATIC PROPERTIES

(76) Inventors: Krausche Christian, Rudlingen (CH); Wai Man Wong, Schaffhausen (CH); Stefanie Sand, Hufingen (DE); Michael Hiller, Gailingen (DE); Pedro Cavaleiro, Viersen (DE)

Correspondence Address: FULBRIGHT & JAWORSKI, LLP, 666 FIFTH AVE, NEW YORK, NY, 10103-3198, US

(21) Appl. No.: 12/295,929

(22) PCT Filed: Apr. 3, 2007
(86) PCT No.: PCT/EP2007/003007

§ 371 Date: Oct. 20, 2008

(30) Foreign Application Priority Data
Apr. 4, 2006 (DE) 10 2006 015 775.3

(51) Int. Cl. B32B 27/00; C09D 7/12; C08K 3/30; C08K 5/43

(52) U.S. Cl. 428/220; 106/287.35; 524/420; 524/168

(57) ABSTRACT

Disclosed is a novel thick floor coating that has antistatic properties and contains metal salt solutions in ionic liquids as an antistatic component. Such thick floor coatings are suitable especially for the chemical construction sector and particularly for commercial buildings occupied by the electronics and electrical industry, which are prone to risks caused by electrostatic charges.

The present invention relates to a high-build, floor coating with antistatic properties.

Coating materials are generally electrical insulators, on which high surface charges can accumulate during the production, processing and use of articles produced therefrom.

These static charges lead to undesired effects and serious risks, extending from attraction of dust, adhesion of hygienic contaminants, disruption of electronic components via spark flashovers, physiologically undesirable electric shocks, ignition of combustible liquids in containers or pipes in which these are stirred, poured, conveyed and stored as far as dust explosions, for example during transfer of the contents of large packs comprising dusts. The undesired electrostatic accumulation of dust on the surface of coating materials can lead to more rapid damage on exposure to mechanical loads and thus to a shorter-service life of consumer articles.

Inhibition of static charging of these coatings or its minimization to a non-hazardous level is therefore of great interest.

A widely used method permitting dissipation of charges and minimization of static charging is the use of antistatic agents, i.e. nonionic or ionic substances having interfacial activity and in particular ammonium salts and alkali metal salts, the forms in which these are mainly used being that of external and internal antistatic agents.

External antistatic agents in the form of aqueous or alcoholic solutions are applied by spraying, spreading or dip coating to the surface of the coating materials and then the material is sir dried. The residual antistatic film is effective on almost all of the surfaces but has the disadvantage that it is very easily unintentionally removed by the action of friction, or liquid.

Unlike the internal antistatic agents, whose molecules subsequently migrate outward from the interior of the hardened coating materials, external antistatic agents have no long-term effectiveness, because of the lack of any depot effect. It is therefore preferable to use internal antistatic agents, these being added as far as possible in pure form or in the form of concentrated formulations to the coating materials. The distribution of the internal antistatic agents is homogeneous after hardening of the coating materials, and they therefore become effective everywhere in the resultant hardened layer, instead of being present only at the air interface.

The current theory, for which there is experimental evidence, is that, the limited compatibility of the molecules causes them to migrate continuously to the surfaces of the coating materials, where they increase their concentration or replace losses. The hydrophobic portion, here remains in the coating materials, while the hydrophilic portion binds water present in the atmosphere and forms a conductive layer which can dissipate charges to the atmosphere at voltage levels as low as a few tens or hundreds, rather than only when dangerous levels of thousands of volts have been reached. This ensures that an effective amount of antistatic agents is present at the surface over a prolonged period.

However, the migration rate (diffusion velocity) is a critical factor in this approach:

If it is too high, low-energy (e.g. crystalline) structures can form, and these structures lose the ability to bind moisture, the result being a significant reduction in antistatic effect and generation of undesired greasy films on the surface, with all of the associated disadvantages in terms of aesthetics and of process technology, and also a risk of reduced effectiveness.

If the migration rate is excessively low, no effect is achieved, or no adequate effect is achieved within a useful period.

Combinations of rapidly and slowly migrating antistatic agents have therefore previously been used, in order to achieve not only a sufficiently rapid initial effect but also a long-term effect lasting for weeks and months.

Surface resistances of typical, hardened coating materials are in the range from 10¹⁴ to 10¹¹ ohms, and these materials can therefore accumulate voltages of up to 15 000 volts. Effective antistatic agents should therefore be capable of reducing the surface resistances of the coating materials to 10¹⁰ ohms or less.

Another factor to be considered alongside this is that antistatic agents can affect the physical and technical properties of the hardened coating materials, for example surface profile, substrate wettability, substrate adhesion, scalability and heat resistance. In order to minimize these effects, therefore, they should, be effective even at very low concentrations. Typical dosages of antistatic agents currently used are from 0.01 to 3 wt.-%, based on the total weight of the coating material.

Metal salts are known and effective antistatic agents. However, they have the disadvantage that they have to be dissolved prior to use in order to give homogeneous dispersion in coating materials. Conventional solvents are alcohols, ethers, esters, polyethers, cyclic ethers, cyclic esters, amides, cyclic amides, aromatic compounds or very generally organic solvents.

However, solubility is sometimes very low, and large amounts of solvent therefore have to be used to obtain sufficiently effective initial concentrations.

If these antistatic agent formulations are used in transparent coating materials, they have the disadvantage that they can adversely affect the optical properties of the final product.

In reactive multicomponent systems, for example those used in the preparation of reactive polyurethane coatings, reactive groups present in the solvent or in other constituents of the antistatic agent formulations can sometimes interfere in the reaction and thus in particular alter the physical properties of the final product. Under practical conditions, therefore, the metal salts are preferably dissolved in one of the constituents of the formulation, in the case of polyurethanes this is generally the alcohol component, i.e. di- or polyols, these then being reacted with isocyanate components to give the polymer matrix. Because of the wide variety of polyols that can be used, it would then be necessary to provide a correspondingly wide variety of solutions. For this reason, these antistatic agents/metal salts are often dissolved in solvents which are a constituent of all of the formulations, e.g. ethylene glycol, propylene glycol, or else other reactive organic solvents. A disadvantage here is that, in order to minimize alteration of the physical properties of the final product, the content of these constituents of the formulation, which are then not merely used as reactive component in the polyurethane formulation but, either additionally or else exclusively, are used as solvent in the antistatic formulation, is not usually permitted to be higher in total in the polyurethane formulation than would be the case without addition of the antistatic formulation.

Attempts have previously been made to provide solvents which dissolve metal salts and which can be used universally and which have high solvent power for a wide variety of metal salts. They should moreover be substantially inert with respect to the reaction components or else be a constituent of the formulation and have no adverse effect on the physical properties of the final product. The novel solvent should also have an improved solvent characteristic for metal salts, and the resultant solution composed of solvent and metal salt here is intended to have better antistatic properties in coating materials.

To this end, certain ionic liquids are used, these being better solvents than the abovementioned di- and polyols and familiar organic solvents for a variety of metal salts. Preparation of effective antistatic agent formulations is intended to require significantly smaller amounts of solvent in order to introduce an effective content of metal salt for improvement of conductivity in coating materials (patent application not yet published). It is true that said document provides a previous description of the use of ionic liquids as solvents for metal salts, where organic solvents or dispersion media can also be added to such mixtures in order to obtain maximum content of conductive salt. There is also a previous description of the use of said systems in coating materials, printing inks and/or print coatings. The coating materials mentioned in this context are exclusively low-viscosity systems which are applied in a thin layer mostly in the form of a paint or coating. Neither the description nor the examples indicates that such antistatic agents are also used in high-build coatings, these having a fundamentally different structure and also being used in other application sectors with different requirements.

Dissipative floors have to be capable of controlled dissipation of static charges, and specifically structured systems are therefore generally used, their main constituents being, alongside a base coat, a highly conductive coating and a conductive topcoat, the conductivity here being in essence achieved by using carbon fibers. Finally, the conductivity coating must then have an earthing connection.

The floors known as ESD floors have been designed to maximize avoidance of static charges and to dissipate them in a defined manner. These functions can be checked not only by conventional electrode measurements but also via measurement of body voltage generation, and use of a body/shoe/floor/earth test system to measure ability to dissipate body voltage, and also by use of time-limited body voltage discharge (decay time). Examples of relevant standards here are CEI IEC 61340-5-1, IEC 61340-4-1 and IEC 61340-4-5. The structure of these ESD floors is like that of the dissipative systems, but also has at least one thin sealing surface-conductivity layer. Additional use can also be made of surface-conductivity topcoats, where surface conductivity is obtained by using conductive fillers and pigments. However, such systems are very expensive. The layer thickness tolerance of these coatings is moreover generally very restricted, and the quaternary ammonium compounds also used therein are not sufficiently effective.

Various binder systems are used as polymer matrix both for dissipative floors and for ESD floors. The most frequently used are amine-hardened epoxy resins, aromatic and aliphatic polyurethane systems, methacrylates which crosslink by a free-radical route (PMMA floors) and vinyl esters. High application cost is needed in order to achieve the desired ESD properties, a general requirement here being to apply expensive top layers.

An object of the present invention, derived from the disadvantages described for the prior art, is to provide a high-build floor coating with antistatic properties. This should be achieved without use of additional sealing materials and without the layer-thickness sensitivity known to be disadvantageous, and naturally under economically advantageous conditions, and in particular advantageous raw materials should be used.

This object, has been achieved via a high-build floor coating which comprises, as antistatic component, solutions of metal salts in ionic liquids.

Surprisingly, it has been found that this system achieved all of the objects set, while in particular entirely avoiding scattering of dissipative values as a function of the particular layer thickness selected. Furthermore, there is no occurrence of the increasing proportions of dead spots that otherwise occur with increasing layer thickness. The inventive high-build floor coating therefore eliminates sensitivity to layer thickness, a disadvantageous effect found elsewhere. Nor could it have been expected that the high-build floor coating proposed can simultaneously satisfy not only the requirements placed upon dissipative capabilities but also those placed, upon ESD systems, in a single layer. This method permits relatively low-cost production of high-build floor coatings on which very little electrostatic charge then accumulates, and it is also possible here, as a function of the particular application sector, to combine the inventively significant antistatic component with other conductive components for controlled adjustment of the performance of the coating product. This is particularly advantageous in the electronics industry, since in that specific application sector the only possibility hitherto has been use of thin-layer systems which are moreover impossible to obtain without great expense and are also have significant long-term-adhesion disadvantages.

The inventive coating system is based on the use of ionic liquids as solvents (compatibilizers) for metal salts (conductive salts), in particular alkali metal salts, and further organic solvents or dispersion media can be added to these mixtures in order to obtain maximum content of conductive salt.

The term ionic liquids is a general term used for salts which melt at low temperatures (< 100° C.) and which are a novel class of liquids with non-molecular, ionic character. Unlike traditional molten salts, which are high-melting-point, high-viscosity, highly corrosive liquids, ionic liquids are liquid, with relatively low viscosity, even at low temperatures (K. R. Seddon J. Chem. Technol. Biotechnol. 1997, 68, 351-356).

In most cases, ionic liquids are composed of anions, e.g. halides, carboxylates, phosphates, thiocyanate, isothiocyanate, dicyanamide, sulfate, alkyl sulfates, sulfonates, alkylsulfonates, tetrafluoroborate, hexafluorophosphate or bis(trifluoromethylsulfonyl)-imide combined with, for example, substituted ammonium cations, substituted phosphonium cations, substituted pyridinium cations or substituted imidazolium cations; the abovementioned anions and cations are a small selection from the large number of possible anions and cations, and therefore there is no intention of claiming comprehensiveness and there is certainly no intention of specifying any restriction.

The present invention encompasses a variant with respect to the ionic liquids, where these comprise an additive which is intended to improve the solubility of the cations and which can also function as a complexing agent. In this context, crown ethers may be provided in particular, or their cryptans and organic complexing agents, e.g. EDTA. Among the large number of crown ethers that can be used, those whose oxygen number is from 4 to 10 have proved suitable. The specialized forms of the crown ethers that can likewise be used, namely the compounds known as cryptans, are particularly suitable for selective complexing with alkali metal ions or with alkaline earth metal ions.

The ionic liquids used concomitantly according to the invention are composed of at least one quaternary nitrogen compound and/or quaternary phosphorus compound and of at least one anion, and their melting point is below about +250° C., preferably below about +150° C., in particular below about +100° C. The mixtures of ionic liquids and solvent are liquid at room temperature.

The ionic liquids preferably used in the inventive high-build floor coating are composed of at least one cation of the general formulae:

R¹R²R³R⁴N⁺ (I)

R¹R²N⁺═CR³R⁴ (II)

R¹R²R³R⁴P⁺ (III)

R¹R²P⁺═CR³R⁴ (IV)

in which R¹, R², R³, and R⁴ are identical or different and are hydrogen, a linear or branched aliphatic hydrocarbon radical having from 1 to 30 carbon atoms and, if appropriate, containing double bonds, a cycloaliphatic hydrocarbon radical having from 5 to 40 carbon atoms and, if appropriate, containing double bonds, an aromatic hydrocarbon radical having from 6 to 40 carbon atoms, an alkylaryl radical having from 7 to 40 carbon atoms, a linear or branched aliphatic hydrocarbon radical having from 2 to 30 carbon atoms and having interruption by one or more heteroatoms (oxygen, NH, NR′, where R′ is a C₁-C₃₀-alkyl radical, if appropriate containing double bonds, in particular —CH₃) and, if appropriate, containing double bonds, a linear or branched aliphatic hydrocarbon radical having from 2 to 30 carbon atoms and having interruption by one or more functionalities selected from the group of —O—C(O)—, —(O)C—O—, —NH—C(O)—, —(O)C—NH—, —(CH₃)N—C(O)—, —(O)C—N(CH₃)—, —S(O₂)—O—, —O—S(O₂)—, —S(O₂)—NH—, —NH—S(O₂)—, —S(O₂)—N(CH₃)—, N(CH₃)—S(O₂)— and, if appropriate, containing double bonds, a linear or branched aliphatic or cycloaliphatic hydrocarbon radical having from 1 to 30 carbon atoms and having terminal functionalization by OH, OR′, NH₂, N(H)R′, N(R′)₂ (where R′ is a C₁-C₃₀-alkyl radical, if appropriate containing double bonds) and, if appropriate, containing double bonds, or a block- or random-structure polyether —(R⁵—O)ₙ—R⁶, where R⁵ is a linear or branched hydrocarbon radical containing from 2 to 4 carbon atoms, n is from 1 to 100, preferably 2 to 60, and R⁶ is hydrogen or a linear or branched aliphatic hydrocarbon radical having from 1 to 30 carbon atoms and, if appropriate, containing double bonds, a cycloaliphatic hydrocarbon radical having from 5 to 40 carbon atoms and, if appropriate, containing double bonds, an aromatic hydrocarbon radical having from 6 to 40 carbon atoms, an alkylaryl radical having from 7 to 40 carbon atoms, or a —C(O)—R⁷ radical, where R⁷ is a linear or branched aliphatic hydrocarbon radical having from 1 to 30 carbon atoms and, if appropriate, containing double bonds, a cycloaliphatic hydrocarbon radical having from 5 to 40 carbon atoms and, if appropriate, containing double bonds, an aromatic hydrocarbon radical having from 6 to 40 carbon atoms, or an alkylaryl radical having from 7 to 40 carbon atoms.

Other ions that can be used as cations are those derived from saturated or unsaturated cyclic compounds or else from aromatic compounds having in each case at least one trivalent nitrogen atom in a 4- to 10-membered, preferably 5- to 6-membered heterocyclic ring which can, if appropriate, have substitution. A simplified description of these cations (i.e. without giving precise situation and number of double bonds in the molecule) can be given via the general formulae (V), (VI) and (VII) below, where the heterocyclic rings can, if appropriate, also contain a plurality of heteroatoms.

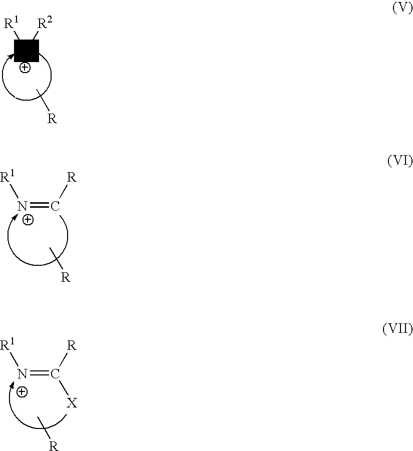

R¹ and R² here are as defined above, and R is hydrogen, a linear or branched aliphatic hydrocarbon radical having from 1 to 30 carbon atoms and, if appropriate, containing double bonds, a cycloaliphatic hydrocarbon radical having from 5 to 40 carbon atoms and, if appropriate, containing double bonds, an aromatic hydrocarbon radical having from 6 to 40 carbon atoms or an alkylaryl radical having from 7 to 40 carbon atoms.

The cyclic nitrogen compounds of the general formulae (V), (VI) and (VII) can be unsubstituted (R═H) or can have mono- or polysubstitution by the radical R, and in the case of polysubstitution by R here the individual radicals R can be different; X is an oxygen atom, a sulfur atom or a substituted nitrogen atom (X=O, S, NR¹). Examples of cyclic nitrogen compounds of the abovementioned type are pyrrolidine, dihydropyrrole, pyrrole, imidazoline, oxazoline, oxazole, thiazoline, thiazole, isoxazole, isothiazole, indole, carbazole, piperidine, pyridine, the isomeric picolines and lutidines, quinoline and isoquinoline.

Other cations that can be used are ions which derive from saturated acyclic compounds, or from saturated or unsaturated cyclic compounds, or else from aromatic compounds, in each case having more than one trivalent nitrogen atom in a 4- to 10-membered, preferably 5- to 6-membered heterocyclic ring. These compounds can have substitution not only on the carbon atoms but also on the nitrogen atoms. They can moreover have been anellated via benzene rings which if appropriate have substitution and/or via cyclohexane rings, to form polynuclear structures. Examples of such compounds are pyrazole, 3,5-dimethylpyrazole, imidazole, benzimidazole, N-methylimidazole, dihydropyrazole, pyrazolidine, pyrazine, pyridazine, pyrimidine, 2,3-, 2,5- and 2,6-dimethylpyrazine, cimoline, phthalazine, quinazoline, phenazine and piperazine. Cations of the general formula (VIII) derived, from imidazole and from its alkyl and phenyl derivatives have proved particularly successful as a constituent of ionic liquid.

Other preferred cations are those which contain two nitrogen atoms and are given by the general formula (VIII)

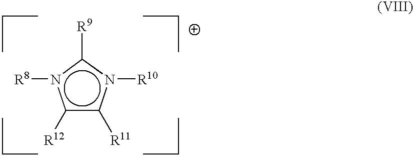

in which R⁸, R⁹, R¹⁰, R¹¹ and R¹² are identical or different and are hydrogen, a linear or branched aliphatic hydrocarbon radical having from 1 to 30 carbon atoms and, if appropriate, containing double bonds, a cycloaliphatic hydrocarbon radical having from 5 to 40 carbon atoms and, if appropriate, containing double bonds, an aromatic hydrocarbon radical having from 6 to 40 carbon atoms, an alkylaryl radical having from 7 to 40 carbon atoms, a linear or branched aliphatic hydrocarbon radical having from 1 to 30 carbon atoms and having interruption by one or more heteroatoms (O, NH, NR′, where R′ is a C₁-C₃₀-alkyl radical, if appropriate containing double bonds) and, if appropriate, containing double bonds, a linear or branched aliphatic hydrocarbon radical having from 1 to 30 carbon atoms and having interruption by one or more functionalities selected from the group of —O—C(O)—, —(O)C—O—, —NH—C(O)—, —(O)C—NH—, —(CH₃)N—C(O)—, (O)C—N(CH₃)—, —S(O₂)—O—, —O—S(O₂)—, —S(O₂)—NH—, —NH—S(O₂)—, —S(O₂)—N(CH₃)—, —N(CH₃)—S(O₂)— and, if appropriate, containing double bonds, a linear or branched aliphatic or cycloaliphatic hydrocarbon radical having from 1 to 30 carbon atoms and having terminal functionalization by OH, OR′, NH₂, N(H)R′, N(R′)₂ (where R′ is a C₁-C₃₀-alkyl radical, if appropriate containing double bonds) and, if appropriate, containing double bonds, or a block- or random-structure polyether —(R⁵—O)ₙ—R⁶, where R⁵ is a hydrocarbon radical containing from 2 to 4 carbon atoms, n is from 1 to 100, and R⁶ is hydrogen or a linear or branched aliphatic hydrocarbon radical having from 1 to 30 carbon atoms and, if appropriate, containing double bonds, a cycloaliphatic hydrocarbon radical having from 5 to 40 carbon atoms and, if appropriate, containing double bonds, an aromatic hydrocarbon radical having from 6 to 40 carbon atoms, an alkylaryl radical having from 7 to 40 carbon atoms, or a —C(O)—R⁷ radical, where r; is a linear or branched aliphatic hydrocarbon radical having from 1 to 30 carbon atoms and, if appropriate, containing double bonds, a cycloaliphatic hydrocarbon radical having from 5 to 40 carbon atoms and, if appropriate, containing double bonds, an aromatic hydrocarbon radical having from 6 to 40 carbon atoms, or an alkylaryl radical having from 7 to 40 carbon atoms.

The ionic liquids inventively present in the high-build floor coating are composed of at least one of the abovementioned cations, combined in each case with at least one anion. Preferred anions are selected from the group of the halides, bis(perfluoroalkylsulfonyl)amides and -imides, e.g. bis(trifluoromethylsulfonyl)imide, alkyl- and aryltosylates, perfluoroalkyltosylates, nitrate, sulfate, hydrogensulfate, alkyl and aryl sulfates, polyether sulfates and polyethersulfonates, perfluoroalkyl sulfates, sulfonate, alkyl- and arylsulfonates, perfluorinated alkyl- and arylsulfonates, alkyl- and arylcarboxylates, perfluoroalkylcarboxylates, perchlorate, tetrachloroaluminate, saccharinate. Anions from dicyanamide, thiocyanate, isothiocyanate, tetraphenyl-borate, tetrakis(pentafluorophenyl)borate, tetrafluoro-borate, hexafluorophosphate, polyether phosphates and phosphate are likewise preferred.

It is of vital importance that the amount of the components (ionic liquid(s)+conductive salt(s)+solvent) present in the ready-to-use mixture which is inventively present as antistatic agent in the high-build floor coating is sufficient to give the maximum content of conductive salt(s) and preferably to make the mixture liquid at < 100° C., particularly preferably at room temperature.

High-build floor coatings inventively preferred are those which comprise, as ionic liquids or their mixtures, combinations in which the cation is selected from 1,3-dialkylimidazolium, 1,2,3-trialkylimidazolium, 1,3-dialkylimidazolinium and 1,2,3-trialkylimidazolium cation and in which the anion is selected from the group of the halides, bis(trifluoromethylsulfonyl)-imide, perfluoroalkyl tosylates, alkyl sulfates and alkylsulfonates, perfluorinated alkylsulfonates and perfluorinated alkyl sulfates, perfluoroalkyl-carboxylates, perchlorate, dicyanamide, thiocyanate, isothiocyanate, tetraphenylborate, tetrakis(penta-fluorophenyl)borate, tetrafluoroborate, hexafluoro-phosphate. It is moreover possible to use simple, commercially available, acyclic quaternary ammonium salts, e.g. TEGO® IL T16ES, TEGO® IL K5MS or Rezol Heqams (products of Goldschmidt GmbH).

Marked reductions in surface resistances are generally obtained with mixtures in which the mixing ratio of ionic liquid to alkali metal salt is in the range from 1:10 to 10:1. Content of the alkali metal salt in such a mixture should be from 0.1 to 75% by weight, preferably from 0.5 to 50% by weight, particularly preferably from 5 to 30% by weight.

The salts used inventively in the high-build floor coating are the simple or complex compounds conventionally used in this sector, particular examples being alkali metal salts of the following anions: bis(perfluoroalkylsulfonyl)amide or -imide, e.g. bis(trifluoromethylsulfonyl)imide, alkyl- and aryltosylates, perfluoroalkyltosylates, nitrate, sulfate, hydrogensulfate, alkyl and aryl sulfates, polyether sulfates and polyethersulfonates, perfluoroalkylsulfates, sulfonate, alkyl- and arylsulfonates, perfluorinated alkyl- and arylsulfonates, alkyl- and arylcarboxylates, perfluoroalkylcarboxylates, perchlorate, tetrachloro-aluminate, saccharinate, preferably anions of the following compounds: thiocyanate, isothiocyanate, dicyanamide, tetraphenylborate, tetrakis(pentafluorophenyl)borate, tetrafluoroborate, hexafluorophosphate, phosphate and polyether phosphates.

Preferred mixtures are in particular those which comprise, as alkali metal, salt, NaSCN or NaN(CN)₂ and KPF₆ and an imidazolinium or imidazolium salt, preferably 1-ethyl-3-methylimidazolium ethyl sulfate, 1-ethyl-3-methylimidazolium hexafluorophosphate, and, as ionic liquid, 1-ethyl-3-methylimidazolium ethyl sulfate/NaN(CN)₂ or 1-ethyl-3-methylimidazolium hexafluorophosphate/NaN(CN)₂.

The present invention provides variants in which the coating matrix of the claimed high-build floor coating is composed of at least one polyurethane, epoxy resin, polyester resin, acrylate, methacrylate or vinyl ester. The present invention moreover provides that the coating matrix of the high-build floor coating comprises fillers and/or pigments, which preferably have conductive properties. Those that can be used, here are in particular carbon fibers, e.g. based on PAN, pitch and rayon, graphite, carbon black, metal oxides and metal alloy oxides. Fillers and pigments coated with components which give them conductive properties are likewise suitable. Here again, graphites, carbon blacks and metal oxides or metal alloy oxides are particularly suitable.

The claimed high-build floor coating is not restricted to specific formulations which comprise the antistatic component in defined compounds. However, it is advisable to admix amounts of from 0.01 to 30 wt.-% and preferably from 0.1 to 20 wt.-% of the antistatic component with the high-build floor coating.

The layer thickness of the claimed system is particularly preferably from 2 to 4 mm, corresponding to its designation as a high-build floor coating. The layer thickness of the novel high-build floor coating can generally have a lower limit of 0.2 cm, and suitable upper limits here are likewise up to 2.0 cm, preferably up to 1.0 cm and particularly preferably up to 6 mm.

The hardness range for light to medium mechanical loading is generally from 65 to 80 Shore D. The minimum hardness for walkable surfaces is preferably Shore A 75.

The present invention encompasses not only the high-build floor coating itself but also its use in the construction chemistry sector and in particular for assembly areas and industrial buildings of the electronics and electrical industry. The claimed high-build floor coatings are also suitable for buildings, and very generally application sectors, where there are risks due to electrostatic charges and where there is therefore also a particular requirement for explosion protection.

An overall feature of the high-build coatings described is that they have very little susceptibility to electrostatic charging; in particular, they can be adapted with precision for the particular intended use via a precisely matched combination of the additives present therein with further conductive components. Because of the specific ingredients, these high-build floor coatings can be produced at low cost and can also be used in application sectors for which the only products apparently suitable hitherto were thin-layer coatings.

The examples below illustrate the advantages of the present invention.

### EXAMPLES

Antistatic agents of the following constitution were used in inventive mixes 4 and 5:

The synergistic mixture composed of ionic liquid, conductive salt and organic solvent was prepared using a magnetic stirrer. For antistatic agent 1, an equimolar amount of the component ethylbis(polyethoxy-ethanol)tallowalkylammonium ethyl sulfate (Tego® IL T16ES) as ionic liquid was mixed with calcium thiocyanate as conductive salt. As antistatic agent 2, an equimolar mixture was used, composed of 1,3-dimethylimidazolium methyl sulfate as ionic liquid and lithium bis(trifluoromethylsulfonyl)imide as conductive salt.

The epoxy resin component was based on the glycidyl polyether of 2,2-bis(4-hydroxyphenyl)propane (bisphenol A). Ethyltriglycol methacrylate (ETMA) was used as reactive diluent.

Mix 1 (comparison)

| | | |
|---|---|---|
| Epoxy resin | 37 | parts by weight |
| Reactive diluent | 5 | parts by weight |
| Benzyl alcohol | 7.3 | parts by weight |
| Chalk/SiO₂ (filler) | 49 | parts by weight |
| Tego Airex 940 | 1.5 | parts by weight |
| (antifoam) | | |
| Carbon fiber | 0.2 | part by weight |

| | |
|---|---|
| Antistatic agent | none |

Mix 2 (comparison)

| Epoxy resin | 37 | parts by weight |
|---|---|---|
| Reactive diluent | 5 | parts by weight |
| Benzyl alcohol | 5.5 | parts by weight |
| Chalk/SiO₂ (filler) | 34 | parts by weight |
| Tego Airex 940 | 1.5 | parts by weight |
| (antifoam) | | |
| Carbon fiber | none | |
| Conductive filler | 15 | parts by weight |

| | |
|---|---|
| Antistatic agent | none |

Mix 3 (comparison)

| | | |
|---|---|---|
| Epoxy resin | 37 | parts by weight |
| Reactive diluent | 5 | parts by weight |
| Benzyl alcohol | 5.5 | parts by weight |
| Chalk/SiO₂ | 34 | parts by weight |
| (filler) | | |
| Tego Airex 940 | 1.5 | parts by weight |
| (antifoam) | | |
| Carbon fiber | 0.2 | part by weight |
| Conductive filler | 15 | parts by weight |

| | |
|---|---|
| Antistatic agent | none |

Mix 4

| | | |
|---|---|---|
| Epoxy resin | 37 | parts by weight |
| Reactive diluent | 5 | parts by weight |
| Benzyl alcohol | 5.3 | parts by weight |
| Chalk/SiO₂ (filler) | 49 | parts by weight |
| Tego Airex 940 | 1.5 | parts by weight |
| (antifoam) | | |
| Carbon fiber | 0.2 | part by weight |
| Antistatic agent 1 | 2 | parts by weight |

Mix 5

| Epoxy resin | 37 | parts by weight |
|---|---|---|
| Reactive diluent | 5 | parts by weight |
| Benzyl alcohol | 5.5 | parts by weight |
| Chalk/SiO₂ (filler) | 49 | parts by weight |
| Tego Airex 940 | 1.5 | parts by weight |
| (antifoam) | | |
| Carbon fiber | none | |
| Antistatic agent 2 | 2 | parts by weight |

All of the mixes were hardened stoichiometric ratio with a standard amine hardener of Aradur 43 type and were applied, in some cases in different layer thicknesses.

The conductivity lacquer used comprised an aqueous epoxy material whose surface resistance was in the region of 10⁴ ohms. The following parameters were determined:

| | | | Body | | | | |
|---|---|---|---|---|---|---|---|
| | | | voltage | Body | | | |
| | Layer | Earthing | dissipation | voltage | | Decay | |
| | thickness | resistance | resistance | generation | | time | |
| Mix 4 | 1.5 mm | 10⁴ ohms | 10⁶ ohms | <50 | V | <0.5 | sec |
| | 3.0 mm | 10⁴ ohms | 10⁶ ohms | <50 | V | <0.5 | sec |
| | 4.0 mm | 10⁴ ohms | 10⁶ ohms | <50 | V | <0.5 | sec |
| Mix 1 | 1.5 mm | 10⁴ ohms | 10⁷ ohms | ~500 | V | 3 | sec |
| | 3.0 mm | 10⁹ ohms | 10⁸ ohms | ~500 | V | 4 | sec |
| Mix 5 | 3.0 mm | 10⁸ ohms | 10⁸ ohms | <50 | V | <0.5 | sec |
| Mix 2 | 0.5 mm | 10⁷ ohms | 10⁷ ohms | ~100 | V | <1 | sec |
| | 1.0 mm | 10⁸ ohms | 10⁹ ohms | ~150 | V | <1 | sec |
| Mix 3 | 1.5 mm | 10⁴ ohms | 10⁶ ohms | ~150 | V | <1 | sec |
| | 3.0 mm | 10⁶ ohms | 10⁶ ohms | ~200 | V | <2 | sec |
| | 4.0 mm | 10⁹ ohms | 10⁹ ohms | ~500 | V | <4 | sec |

1-13. (canceled)

14. A high-build floor coating comprising as an antistatic component a solution of a metal salt in an ionic liquid.

15. The high-build floor coating as in claim 14, wherein the ionic liquid comprises at least one cation of the formulae (I), (II), (III) or (IV)
R¹R²R³R⁴N⁺ (I)
R¹R²N⁺═CR³R⁴ (II)
R¹R²R³R⁴P⁺ (III)
R¹R²P⁺═CR³R⁴ (IV)
wherein R¹, R², R³ and R⁴ are independently selected from the group consisting of
(a) hydrogen,
(b) a linear or branched aliphatic hydrocarbon radical having from 1 to 30 carbon atoms,
(c) a cycloaliphatic hydrocarbon radical having from 5 to 40 carbon atoms,
(d) an aromatic hydrocarbon radical having from 6 to 40 carbon atoms,
(e) an alkylaryl radical having from 7 to 40 carbon atoms,
(f) an linear or branched aliphatic hydrocarbon radical having from 2 to 30 carbon atoms and having interruption by one or more heteroatoms selected from the group consisting of O, NH, and NR′, wherein R′ is a C₁-C₃₀-alkyl radical,
(g) an aliphatic hydrocarbon radical having from 2 to 30 carbon atoms and having interruption by one or more of —O—C(O)—, —(O)C—O—, —NH—C(O)—, —(O)C—NH—, —(CH₃)N—C(O)—, —(O)C—N(CH₃)—, —S(O₂₎—O—, —O—S(O₂)—, —S(O₂)—NH—, —NH—S(O₂>, —S(O₂)—N(CH₃)—, and —N(CH₃)—S(O₂)—,
(h) an aliphatic hydrocarbon radical having from 1 to 30 carbon atoms and having terminal groups selected from the group consisting of OH, OR′, NH₂, N(H)R′ and N(R′)₂, wherein R′ is a C₁-C₃₀-alkyl radical, or a block- or random-structure polyether —(R⁵—O)ₙ—R⁶,
(i) a cycloaliphatic hydrocarbon radical having from 3 to 30 carbon atoms and having terminal groups selected from the group consisting of OH, OR′, NH₂, N(H)R′ and N(R′)₂, wherein R′ is a C₁-C₃₀-alkyl radical, or a block- or random-structure polyether —(R⁵⁻⁰)ₙ—R⁶
wherein
R⁵ is a hydrocarbon radical containing from 2 to 4 carbon atoms,
n is from 1 to 100,
R⁶ is selected from the group consisting of hydrogen, an aliphatic hydrocarbon radical having from 1 to 30 carbon atoms, a cycloaliphatic hydrocarbon radical having from 5 to 40 carbon atoms, an aromatic hydrocarbon radical having from 6 to 40 carbon atoms, an alkylaryl radical having from 7 to 40 carbon atoms, and a —C(O)—R⁷ radical; and
R⁷ is selected from the group consisting of an aliphatic hydrocarbon radical having from 1 to 30 carbon atoms, a cycloaliphatic hydrocarbon radical having from 5 to 40 carbon atoms, an aromatic hydrocarbon radical having from 6 to 40 carbon atoms, and an alkylaryl radical having from 7 to 40 carbon atoms.

16. The high-build floor coating as in claim 14, wherein the ionic liquid comprises at least one cation of the formulae (V), (VI), (VII) 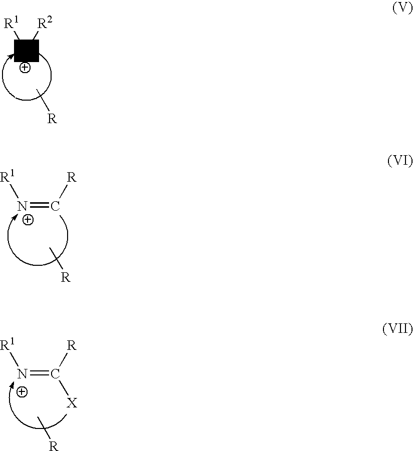
wherein
R is selected from the group consisting of hydrogen, an aliphatic hydrocarbon radical having from 1 to 30 carbon atoms, a cycloaliphatic hydrocarbon radical having from 5 to 40 carbon atoms, an aromatic hydrocarbon radical having from 6 to 40 carbon atoms and an alkylaryl radical having from 7 to 40 carbon atoms; and
X is an oxygen atom, a sulfur atom or NR′.

17. The high-build floor coating as in claim 14, wherein the ionic liquid comprises at least one cation of the formula (VIII) 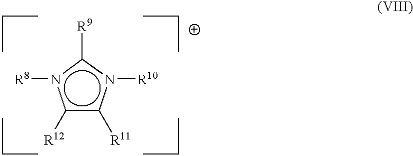
wherein
R⁸, R⁹, R¹⁰, R¹¹ and R¹² are independently selected from the group consisting of
(a) hydrogen,
(b) a linear or branched aliphatic hydrocarbon radical having from 1 to 30 carbon atoms,
(c) a cycloaliphatic hydrocarbon radical having from 5 to 40 carbon atoms,
(d) an aromatic hydrocarbon radical having from 6 to 40 carbon atoms,
(e) an alkylaryl radical having from 7 to 40 carbon atoms,
(f) a linear or branched aliphatic hydrocarbon radical having from 1 to 30 carbon atoms and having interruption by one or more heteroatoms selected from the group consisting of O, NH, and NR′, wherein R′ is a C₁-C₃₀-alkyl radical,
(g) a linear or branched aliphatic hydrocarbon radical having from 1 to 30 carbon atoms and having interruption by one or more of —O—C(O)—, —(O)C—O—, —NH—C(O)—, —(O)C—NH—, —(CH₃)N—C(O)—, —(O)C—N(CH₃>, —S(O₂)—O—, —O—S(O₂)—S(O₂)—NH—, —NH—S(O₂)—, —S(O₂)—N(CH₃)—, and —N(CH₃)—S(O₂)—,
(h) an aliphatic hydrocarbon radical having from 1 to 30 carbon atoms and having terminal groups selected from the group consisting of OH, OR′, NH₂, N(H)R′ and N(R′)₂, wherein R′ is a C₁-C₃₀-alkyl radical, or a block- or random-structure polyether —(R⁵—O)ₙ—R⁶; and
(i) a cycloaliphatic hydrocarbon radical having from 3 to 30 carbon atoms and having terminal groups selected from the group consisting of OH, OR′, NH₂, N(H)R′ and N(R′)₂, wherein R′ is a C₁-C₃₀-alkyl radical, or a block- or random-structure polyether —(R³⁻⁰)ₙ—R⁶; wherein,
R⁵ is a hydrocarbon radical containing from 2 to 4 carbon atoms,
n is from 1 to 100,
R⁶ is selected from the group consisting of hydrogen, an aliphatic hydrocarbon radical having from 1 to 30 carbon atoms, a cycloaliphatic hydrocarbon radical having from 5 to 40 carbon atoms, an aromatic hydrocarbon radical having from 6 to 40 carbon atoms, an alkylaryl radical having from 7 to 40 carbon atoms, and a —C(O)—R⁷ radical; and
R⁷ is selected from the group consisting of an aliphatic hydrocarbon radical having from 1 to 30 carbon atoms, a cycloaliphatic hydrocarbon radical having from 5 to 40 carbon atoms, an aromatic hydrocarbon radical having from 6 to 40 carbon atoms, and an alkylaryl radical having from 7 to 40 carbon atoms.

18. The high-build floor coating as in claim 14, wherein the ionic liquid comprises at least one anion selected from the group consisting of a halide, a bis(perfluoroalkyl-sulfonyl)amide, a bis(perfluoroalkyl-sulfonyl)imide, bis(trifluoromethyl-sulfonyl)imide, an alkyltosylate, an alkyltosylate, a perfluoroalkyltosylate, nitrate, sulfate, hydrogensulfate, an alkyl sulfate, an aryl sulfate, a polyether sulfate, a polyethersulfonate, a perfluoroalkyl sulfate, sulfonate, an alkyl sulfonate, an aryl sulfonate, a perfluorinated alkyl sulfonate, an arylsulfonate, an alkylcarboxylate, an arylcarboxylate, a perfluoroalkylcarboxylate, perchlorate, tetrachloroaluminate, saccharinate, and anions of compounds selected from the group consisting of dicyanamide, thiocyanate, isothiocyanate, tetraphenylborate, tetrakis(pentafluorophenyl)borate, tetrafluoroborate, hexa-fluorophosphate, a polyether phosphate and a phosphate.

19. The high-build floor coating as in claim 14, wherein the ionic liquid comprises at least one cation selected from the group consisting of 1,3-dialkylimidazolium, 1,2,3-trialkylimidazolium, 1,3-dialkylimidazolinium and 1,2,3-trialkylimidazolinium cation and at least one anion selected from the group consisting of a halide, bis(trifluoromethylsulfonyl)-imide, a perfluoroalkyl tosylate, an alkyl sulfate, an alkylsulfonate, a perfluorinated alkylsulfonate, a perfluorinated alkyl sulfate, a perfluoroalkyl-carboxylate, perchlorate, dicyanamide, thiocyanate, isothiocyanate, tetraphenylborate, tetrakis(penta-fluorophenyl)borate, tetrafluoroborate, hexafluorophosphate, and an acyclic quaternary ammonium salt.

20. The high-build floor coating as in claim 14, wherein the ionic liquid comprises at least one additive in the form of a compound which improves the solubility of the cation, or of a complexing agent.

21. The high-build floor coating as in claim 14, wherein at least one salt has been dissolved in the ionic liquid and has been selected from the group of the alkali metal salt of at least one anion selected from the group consisting of bis(perfluoroalkylsulfonyl)amide, bis(perfluoroalkylsulfonyl)imide, an alkyltosylate, an aryltosylate, perfluoroalkyltosylates, nitrate, sulfate, hydrogensulfate, an alkyl sulfate, an aryl sulfate, a polyether sulfate, a polyethersulfonate, a perfluoroalkylsulfate, sulfonate, an alkylsulfonate, an arylsulfonate, a perfluorinated alkyl sulfonate, an arylsulfonate, an alkylcarboxylate, an arylcarboxylate, a perfluoroalkylcarboxylate, perchlorate, tetrachloroaluminate, and saccharinate.

22. The high-build floor coating as in claim 14, wherein the coating matrix comprises at least one polyurethane, epoxy resin, polyester resin, acrylate, methacrylate or vinyl ester.

23. The high-build floor coating as in claim 14, wherein the coating matrix comprises at least one of a filler or a pigment.

24. The high-build floor coating as in claim 14, wherein the amount of the antistatic component is from 0.01 to 30 wt. %.

25. The high-build floor coating as in claim 14 having a layer thickness of up to 2.0 cm.

26. A composition comprising the high-build floor coating of claim 14 on a substrate.
